(19) United States
(12) Patent Application Publication
(10) Pub. No.: US 2022/0335469 A1
(43) Pub. Date: Oct. 20, 2022

(54) METHOD OF CREATING AND USING ID CODE NUMBER BASED ON GRID COORDINATES OF LONGITUDE LINE AND LATITUDE LINE AND METHOD OF PROVIDING OPEN-TYPE INFORMATION SHARING SERVICE USING SAME

(71) Applicant: Soojin JANG, Gwangju (KR)

(72) Inventor: Soojin JANG, Gwangju (KR)

(21) Appl. No.: 17/762,748

(22) PCT Filed: Sep. 23, 2020
(86) PCT No.: PCT/KR2020/012882

§ 371 Date: Mar. 23, 2022

(30) Foreign Application Priority Data
Sep. 24, 2019 (KR) 10-2019-0117543
Jul. 20, 2020 (KR) 10-2020-0089551

(51) Int. Cl. G06Q 30/02; G06Q 10/08

(52) U.S. Cl. CPC G06Q 30/0241; G06Q 10/083

(57) ABSTRACT

The present disclosure provides a method of creating and using an ID code number, the method creating and applying discrimination ID code numbers to places, buildings, natural persons, and tangible⋅intangible system devices and components that are matched with grid coordinates of longitude lines and latitude lines so that all components that act on the internet can be transparently operated, and a method of providing an open-type information sharing service using the method.

### TECHNICAL FIELD

The present disclosure relates to a method of creating and using an ID code number, the method creating and applying discrimination ID code numbers to places, buildings, natural persons, and tangible⋅intangible system devices and components that are matched with grid coordinates of longitude lines and latitude lines so that all components that act on the internet can be transparently operated, and a method of providing an open-type information sharing service using the method. In particular, the present disclosure relates to creating⋅combining, and using ID code numbers based on grid coordinates of longitude lines and latitude lines, information of points, lines, surfaces, cubes, which are creatures of the longitude-latitude line coordinates, and grid information of coordinates.

### BACKGROUND ART

The amount of mail is decreasing throughout the world due to development of various means of communication including the internet. It is required to grow sale of existing businesses, find out new businesses, etc. for stable growth of the mail service that is provided by Korea Post. Up to now, an internet post office (ePost) based in the internet has been constructed in addition to the traditional post office windows in the customer reception environment for a mail service. Recently, the mobile market including mobile phones and PDAs has been rapidly developed and is reaching a maturity stage.

In particular, it is necessary to accurately define and verify a concerned-person and an object in order to secure accurate information of input and output that are necessarily need in the business environment of the 4th industry, so ID codes that can be generally used all over the world throughout the industry are keenly needed.

Recently, a method that can substantially deliver email in offline by collecting the addresses to which mails are delivered using the email addresses of receivers has been studied and developed.

In relation to this, a configuration that includes a first database storing communication information and address information of receivers and a delivery service controller acquiring the address information of a receiver from data stored in the first database on the basis of the communication information of the receiver input by a sender and that can send mail or a letter to the address of a receiver even if a sender does not know the address of the receiver as long as the sender know only email information or a phone number has been disclosed in “Apparatus for delivering good and controlling method thereof” of Korean Patent Application Publication No. 2009-0078217 (published on 17 July, 2009) which is a prior art.

However, since email and offline mail still provide the same function on two kinds of platforms, the effect is repeated. Further, in order to use email, it is possible to make an email account after joining by inputting an address, a name, sex, a phone number, etc. on a portal site, checking whether the email address can be used, and undergoing mobile phone authentication, so the procedure is complicated and there is a possibility of leakage of excessive personal information. Further, a mailbox or a postbox has a letter delivery function, the same as email, but is gradually not used due to the function repeated by email, so it is required at present to develop a platform integrating these two functions.

A configuration in which a cyber post-office box service using a zip code creates a cyber post-office address including a zip code indication region, a real residence place indication region, and a real resident indication region and assigning a corresponding cyber post-office box to the resident of each address on the basis of addresses so that mail that is delivered to each address or the resident of each address can be replaced with email has been disclosed in “Cyber post-office box service system and method using postal code” of Korean Patent No. 10-0354478 (registered on 7 Dec. 2002).

A configuration that can make a general internet post-office box that classifies and stores mail matters, which are delivered to addresses or resident registration numbers that are real names, to corresponding addresses or resident registration number IDs so that the mail matters can be opened by constructing in advance all internet posit-office box accounts in the whole country which have the nationally addresses and resident registration numbers are IDs has been disclosed in “The internet post-office box service which can replace offline mail by address based ID” in Korean Patent Application Publication No. 2011-0090240 (published on 10 Aug. 2011) that is another prior art.

However, there is a problem that there is fundamental limitation in terms of general standards that can be applied to all objects due to inherent limitation caused by difference and non-existence of a post system in each country and due to non-generality and inaccuracy caused by the inherent limitation.

As described above, similar measures have been studied, developed, and proposed, but they cannot be fundamental solutions due to inherent limitation of application and inefficiency, and an increase in antisocialism (malicious comments, fake news spreader such as non-verified personal broadcasting, voice phishing) and cyber crimes (hacking), which are caused by anonymity of the concerned-persons, is substantially an obstacle of all kinds of growth based on the internet and also causes astronomical social costs.

Accordingly, there is an increasing necessity of a measure for overcome the reality in which the necessity of finding out and cope with the tendency of potential criminals or confirmed cases of contagious diseases who may be detrimental to public profit or safety.

Further, technologies of the related art have been proposed to solve the problems of constructing open-type information on the basis of zip codes or addresses in the related art, but they are not used or have partial effect at the most due to limitation of application⋅inaccuracy⋅non-generality, etc.

In particular, since it is necessary to accurately define and verify a concerned-person and an object in order to secure accurate information of input and output that are necessarily need in the business environment of the 4th industry in 21th century, general ID codes are keenly required throughout the industry.

Further, as described above, similar measures have been proposed, but they cannot be fundamental solutions due to inherent limitation of application and inefficiency, and an increase in antisocialism (malicious comments, fake news spreader such as non-verified personal broadcasting, voice phishing) and cyber crimes (hacking), which are caused by anonymity of the concerned-persons, is substantially an obstacle of all kinds of growth and also causes astronomical social costs.

### DISCLOSURE

### Technical Problem

Accordingly, the present disclosure has been made in an effort to solve the problems described above and an objective of the present disclosure is to provide a method of creating and using an ID code number, the method creating and applying discrimination ID code numbers to places, buildings, natural persons, and tangible⋅intangible system devices and components that are matched with grid coordinates of longitude lines and latitude lines so that all components that act on the internet can be transparently operated.

Another objective of the present disclosure is to provide a device for creasing ID code numbers based on grid coordinates of longitude lines and latitude lines, information of points, lines, surfaces, cubes, which are creatures of the longitude-latitude line coordinates, and grid information of coordinates, a means of open-type information that can specify a position and an individual by open-type information, and a method of construct a defense net against military threatening weapons.

Another objective of the present disclosure is to provide a method of creasing and using a grid by grid coordinates of longitude lines and latitude lines, the method being used as a means of open-type information that can specify a position and an individual by open-type information by combining numerical values, such as inherent positions and altitudes of coordinates of longitude lines and latitude lines configured as grid elements, and projective coordinates into ID code numbers for specific spaces, buildings, places, etc. in a map, being able to propose or show specific points or areas through general ID code numbers using points, lines, surfaces, and cubes that are created by grid coordinates of longitude lines and latitude lines, being able to find out variation of a real-time position of a specific object (natural person) connected with a Global Navigation Satellite System (GNSS), and being able to defend threatening attack weapons (a missile, a fighter-bomber, etc.).

Another objective of the present disclosure is to provide a method of encoding IDs for specific spaces, building, places, residents, etc. in a map, and of creating and assigning an open-type information means, etc. for email, phone numbers, etc. based on the IDs by using 3D grid coordinates of longitude lines and latitude lines as a means of open-type information that can specify positions and individuals by open-type information.

The objects of the present disclosure are not limited to those described above and other objects may be made apparent to those skilled in the art from claims.

### Technical Solution

In order to achieve the objectives, a method of creating an ID code number based on grid coordinates of longitude lines and latitude lines according to the present disclosure to achieve the objectives is characterized by using inherent information about a visual perspective map of grid coordinates of longitude lines and latitude lines matched or assigned to at least one or a specific place, building, natural person, and tangible⋅intangible system and object on the internet as an ID code number individually or in a combination, using an open-type information sharing service provision server.

Preferably, the visual projective map may be a visual projective map of a 3D building matched with and passing through longitude line/latitude line grid coordinates in an upper surface grid, or a projective visual map matched with passing through a 3D building in an upper⋅lower surface longitude line/latitude line grid.

In order to achieve the objectives, a method of creating an ID code number based on grid coordinates of longitude lines and latitude lines according to the present disclosure to achieve the objectives is also characterized by using inherent information based on grid coordinates of longitude lines and latitude lines matched or assigned to at least one or a specific place, building, natural person, and tangible⋅intangible system and object on the internet as an ID code number individually or in a combination, using an open-type information sharing service provision server.

Preferably, the grid coordinates may include a longitude, a latitude, an altitude, and projective coordinates.

Preferably, the ID code number may include a step of creating a 3D map using a grid including a point, a line, and a surface on the basis of an plane coordinate system based on longitude lines and latitude lines, and a step of using information of a creature, which includes a ropeway, an orbit, a longitude, a trace target object guide line, a sensor, a traffic lane, and a traffic road as an ID code number individually or in a combination.

Preferably, the 3D map provides a cube, the cube is included in a mother cube and includes information about a 4-directional picture and a 4-directional drone view for replacing a road view corresponding to the grid, the mother cube includes a numerical value related to the cube and information about a creature, and the 4-directional picture and the 4-directional drone view correspond to (are matched with) a map at grid coordinates of longitude lines and latitude lines.

Preferably, the method may further include a step of creating a perspective visual map matched with and passing through 3D building space by longitude line and latitude line coordinates as a new world administrative address system when specifying a position or a place, a building, and an address in a map using the individual or combined ID code number as open-type information.

Preferably, the ID code number may include a code number generally proposing a specific point or area using a point, a line, a surface, and a cube created by longitude line and latitude line grid coordinates.

In order to achieve the objectives of the present disclosure, a method of providing an open-type information sharing service using grid coordinates of longitude lines and latitude lines is a method of providing an open-type information sharing service that is executed in an open-type information sharing service provision server, and includes: a step of assigning a cyber postbox, which includes combination⋅creation of a cyber ID card that is an ID code number based on grid coordinates of longitude lines and latitude lines assigned for each of specific position, building, and natural person's residential registration residence place; a step of storing a content in the cyber postbox when the content is transmitted to the assigned cyber postbox from at least one information provision terminal; and a step of outputting the content on a user terminal when the cyber postbox floated at a place⋅a building an address in a map on the user terminal, in which the cyber postbox may include a text, an image, or a video that is a result of classifying a business type as at least one category, may allot information about a line, a surface, a cube, and a creature (a route, a traffic lane, etc.) constituting a grid, and may include inherent certain number and size of an ID code number and a creature based on longitude lines and latitude lines (horizontal lines×vertical lines) of a grid, an administrative district, a address house number, and information about surfaces (one of creatures in a grid) configured by combining position name lines, as identifiers in an assigning procedure.

Preferably, the method may further include a step of receiving a content including a delivery place or a delivery area and an advertisement fro at least one advertisement terminal before a step of assigning a cyber postbox, which includes an ID code number based on grid coordinates of longitude lines and latitude lines assigned to each of specific position, building, and natural person's residential registration residence place to a user terminal, and when the content is output from the user terminal, a reserve may be assigned to the user terminal.

Preferably, a code number based on grid coordinates of longitude lines and latitude lines of the cyber postbox may include a PR identifier indicating a business or a store of an individual;

an open-type information sharing service provision server may control the position of the business or a map and a road view of a store to be transmitted to a search terminal and to be output, when the search terminal searches for a code number based on grid coordinates of longitude lines and latitude lines or an address of the cyber postbox; when the search terminal searches for a code number based on grid coordinates of longitude lines and latitude lines or an address of the cyber postbox, the open-type information sharing service provision server may activate an interface for transmitting a call to a business place or a store of an individual on the basis of recognition and SNS transmission/reception with a natural person corresponding to (matched with) a current corresponding longitude line and latitude line grid or coordinates by an ID code combined created on the basis of 3D grid coordinates of longitude lines and latitude lines in the search terminal; and the map may include a 2D, 3D, virtual reality, or augmented reality map.

Preferably, a code number based on grid coordinates of longitude lines and latitude lines of the cyber postbox may include a PR identifier indicating a business or a store of an individual, and when a notice board printed with the code number based on grid coordinates of longitude lines and latitude lines of the cyber postbox is photographed by the user terminal, the open-type information sharing service provision server may control a PR content mapped and stored in advance in the cyber postbox to be output as an augmented reality content on the user terminal.

Preferably, the method may further include: a step of transmitting a password setting request to the user terminal so that a password for opening the cyber postbox is set; and a step of storing the pass word by mapping the password with the cyber postbox when the password is set from the user terminal, after the step of assigning a cyber postbox, which includes a code number based on grid coordinates of longitude lines and latitude lines assigned for each of specific position, building, and natural person's residential registration residence place.

Preferably, step of outputting the content on a user terminal when the cyber postbox floated in a map on the user terminal may include a step of outputting a content in a cyber postbox to be output on the user terminal through an augmented reality when a notice board printed with an ID code number based on 3D grid coordinates of longitude lines and latitude lines of the cyber postbox of the user terminal is photographed by the user terminal.

Preferably, the method may further include a step of providing a list of articles to be delivered to an address of the user terminal as an augmented reality from a home delivery terminal when there is an article to be delivered to the user terminal and a notice board printed with a code number based on grid coordinates of longitude lines and latitude lines of the cyber postbox is photographed by the home delivery terminal, after the step of assigning a cyber postbox, which includes an ID code number based on grid coordinates of longitude lines and latitude lines assigned for each of specific position, building, and natural person's residential registration residence place.

Preferably, the grid may include a point, a line, and a surface; the point, the line, and the surface may constitute a creature individually or in a combination; a size of the grid may be set in consideration of precision; the creature may include a diagram (graphic) of a ropeway, an orbit, a route, a trace target object guide line, a sensor (including a lens or CCTV), and a traffic lane; a 3D map may provide a cube; the cube may include information about a 4-surface picture and a 4-directional drone view for replacing a road view corresponding to the grid; the 4-surface picture and the 4-directional drone view may correspond to (may be matched with) a map at 3D grid coordinates of longitude lines and latitude lines; the cube may be included in a mother cube; and the mother cube may further include a numerical number related to the cube and information about a creature.

Preferably, a creature (particularly, a grid of a longitude line) configured by grid coordinates of longitude lines and latitude lines individually or in a combination may include a configuration of a general new world administrative address system and a visual perspective map of grid coordinates of longitude lines and latitude lines when a position or a place, a building, and an address are specified in a world map.

Preferably, the method may include assigning a function that can defense⋅suppress an invasion weapon to a creature of an altitude-based grid of longitude lines and latitude lines.

Preferably, the line constituting the route may be expressed in a dual unit in a same map by separating and discriminating an other map part and a scale ratio in accordance with a use.

Preferably, a size of the grid for creating a route for autonomous driving may be determined on the basis of a proximate value of allowable precision for autonomous driving, and a size unit of the grid of longitude lines and latitude lines for searching a delivery place map and a movement route may be configured as a dual unit.

### Advantageous Effects

The method of creating and using an ID code number based on grid coordinates of longitude lines and latitude lines according to the present disclosure described above and the method of providing an open-type information sharing service using the method have the following effects.

First, since it is possible to transmit/receive mail or an advertisement by floating a cyber postbox including ID codes indicating specific space or land, building, resident at an actual position in a map, a user can transmit/receive email even if the user does not provide personal information by signing up for a portal site.

Second, since a transmitter can sent mail or an advertisement to an inherent ID code floated in a map even if the transmitter does not know the name or email address of a user, a receiver and a transmitter both can reduce time and costs and it is possible to increase sensitive quality of a user.

Third, it is possible to urge attendants to act with reliability and make an effort for self-cleaning on SNS in the internet relationship and it is possible to prevent side effects due to anonymity by using an open-type ID, that is, a cyber ID card.

Fourth, it is possible to create a point, a line, a surface, a cube, etc. based on 3D grid coordinates of longitude lines and latitude lines and to give functions to the creatures.

Fifth, the present disclosure is adequate to prevent increasing economic inefficiency in business and criminal relationship on the internet and to implement a fair, transparent, and efficiency economic society by fixing a tangible (hardware)⋅intangible (software), human⋅physical reason provider charge principle as a social promise.

Sixth, it is possible to expect a role as a key element that secures safety through inter-verification by an ID code and a real-time connection position by GPS of a longitude line and latitude line grid map in a non-facing industry society.

Seventh, it is possible to take pre post measures by using an ID code, which can function as a filter, as a means for proving and authenticating an alibi of absence at a site (position) in real time in connection with GNSS when connecting to the inner net by assigning the ID code to a tangible (software) component.

Eighth, a body security authentication means is recently used for internet commerce and connection, but the present disclosure can be applied as an alternative that can overcome the problem that reluctance against an inhuman method also exists.

Ninth, it is possible to perform functional compensation that compensates instability in security caused by a PKI electronic signature or a PIN number cipher system verification means.

Tenth, the present disclosure is adequate to prevent increasing economic inefficiency and to implement a fair, transparent, and efficiency economic society by fixing a tangible⋅intangible, human physical reason provider charge principle as a social promise

Eleventh, it is possible to expect a role as a key element that that secures safety through inter-verification by an ID code in a non-facing industry society. In particular, it is possible to scientifically and quickly take measures against the necessity of finding out and coping with tendency of potential crimes or confirmed cases of contagious diseases that may be detrimental to public profit or safety by verifying position variation of an ID code matched and linked with a specific person.

### DESCRIPTION OF DRAWINGS

FIG. 1 is a diagram illustrating a system for providing an open-type information sharing service using grid coordinates of longitude lines and latitude lines according to an embodiment of the present disclosure.

FIG. 2 is a block configuration diagram illustrating an open-type information sharing service provision server included in the system of FIG. 1.

FIG. 3 is a diagram illustrating an embodiment that implements the open-type information sharing service using grid coordinates of longitude lines and latitude lines according to an embodiment of the present disclosure.

FIG. 4 is a diagram showing a process in which data are transmitted/received among components included in the system for providing an open-type information sharing service using grid coordinates of longitude lines and latitude lines of FIG. 1 according to an embodiment of the present disclosure.

FIG. 5 is an operation flowchart illustrating a method of providing an open-type information sharing service using grid coordinates of longitude lines and latitude lines according to an embodiment of the present disclosure.

FIG. 6 is a diagram showing an example of showing (illustrating) a graphic of points⋅lines⋅surfaces that are created at grid coordinates of longitude lines and latitude lines.

FIG. 7a is a diagram showing an embodiment of creating an ID code by combining coordinates of longitude lines and latitude lines.

FIG. 7b is a diagram showing an embodiment of creating a visual grid map by a 3D perspective view of buildings matching with passing through grid coordinates of longitude lines and latitude lines and of creating an ID code based on the map.

FIG. 8 is a diagram showing floating of a cyber postbox for a corresponding position and specific (selected⋅proposed⋅assigned) object, internal⋅external model pictures⋅configuration derivation information of places buildings matched with longitude and latitude line grid.

FIGS. 9a, 9b, and 10 are diagrams illustrating a grid map and traffic roads created by points⋅lines⋅surfaces that are a kind of information derived at grid coordinates of longitude lines and latitude lines.

FIG. 11a is an embodiment that is created and used as a user ID code using tangible⋅intangible systems of an ID code.

FIG. 11b is an embodiment that is applied to a non-facing industry such as remote education and an online business of an ID code, applies a user ID code, and creates and use inter-connector ID codes, position information, etc. that are transmitted received by a GNSS, etc. for real-time connection positions in a grid map of longitude and latitude lines.

FIG. 12 shows (a) an embodiment that is created and used as a user ID code using a pre-movement position of a specific person by applying a static (+) ID, and (b) an embodiment that is created and used as a user ID code using a post-movement position of a specific person by applying a dynamic (−) ID.

### MODE FOR INVENTION

Other objectives, characteristics, and advantages of the present disclosure will be made clear through the detailed description of embodiment referring to the accompanying drawings.

A preferred embodiment of a method of creating and used an ID code number based on grid coordinates of longitude lines and latitude lines according to the present disclosure is described hereafter with reference to the accompanying drawings. However, the present disclosure is not limited to the following embodiments and can be implemented in various ways different from one another, and the embodiments are provided to complete the present disclosure and to completely inform those skilled in art of the scope of the present disclosure. Therefore, the configurations described in the embodiments and drawings of the present disclosure are merely most preferable embodiments but do not represent all of the technical spirit of the present invention. Thus, it should be understood that the present disclosure should be construed as including all the changes, equivalents, and substitutions included in the spirit and scope of the present disclosure at the time of filing this application.

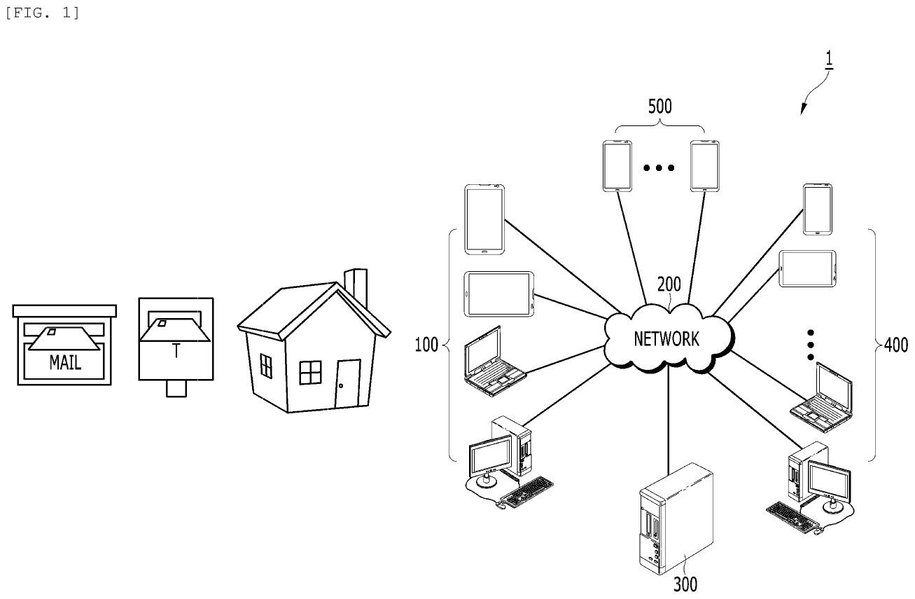

FIG. 1 is a diagram illustrating a system for providing an open-type information sharing service using grid coordinates of longitude lines and latitude lines according to an embodiment of the present disclosure.

Referring to FIG. 1, a system 1 for providing an open-type information sharing service using grid coordinates of longitude lines and latitude lines may include a user terminal 100, an open-type information sharing service provision server 300, at least one information provision terminal 400, at least home delivery terminal 500, and a manager terminal (not shown). However, the system 1 for providing an open-type information sharing service using 3D grid coordinates of longitude lines and latitude lines of FIG. 1 is at the most an embodiment of the present disclosure, so the present disclosure is not limitatively construed through FIG. 1.

In this case, the components of FIG. 1 are usually connected through a network 200. For example, as shown in FIG. 1, the user terminal 100 may be connected with the open-type information sharing service provision server 300 through the network 200. Further, the open-type information sharing service provision server 300 may be connected with the user terminal 100, the at least one information provision terminal 400, the at least one home delivery terminal 500, and the manager terminal through the network 200. Further, the at least one information provision terminal 400 may be connected with the open-type information sharing service provision server 300 through the network 200. Further, the at least one home delivery terminal 500 may be connected with the open-type information sharing service provision server 300 through the network 200. Finally, the manager terminal may be connected with the user terminal 100, the open-type information sharing service provision server 300, the information provision terminal 400, the at least one home delivery terminal 500 through the network 200.

In this case, the network 200 means a connection structure enabling information exchange among nodes such as a plurality of terminals and servers. For example, the network may include RF, a 3GPP (3rd Generation Partnership Project) network, an LTE (Long Term Evolution) network, a 5GPP (5th Generation Partnership Project) network, a WIMAX (World Interoperability for Microwave Access) network, the internet, a LAN (Local Area Network), a Wireless LAN (Wireless Local Area Network), a WAN (Wide Area Network), a PAN (Personal Area Network), a Bluetooth network, an NFC network, a satellite broadcasting network, an analogue broadcasting network, a DMB (Digital Multimedia Broadcasting) network, etc., but is not limited thereto.

In the following description, the term ‘at least one’ is defined as a term including a singular number and plural numbers, and it would be apparent that each component may exist as singular or plural components and may mean a singular number and plural numbers even though the term ‘at least one’ does not exist. Further, the configuration in which each component is provided as a singular or plural components may be changed in accordance with embodiments.

The user terminal 100 may be the terminal of a user that uses a webpage, an app page, a program, or an application related to an open-type information sharing service using grid coordinates of longitude lines and latitude lines. In this case, the user terminal 100 may be a terminal that can output contents including mail, advertisements, etc. received in its cyber postbox when a user inputs a password in accordance with the grid coordinates of longitude lines and latitude lines of the position where the user resides.

In this case, the user terminal 100 may be a plurality of terminals in accordance with the number of people for each household for each place of residence and may be a plurality of terminals that are set to be able to be access when only a password is input through the terminals even at the same place of residence. Further, the user terminal 100 may not use or give a request to delete the cyber postbox provided by the open-type information sharing service provision server 300 and may be a terminal that receives advertisement compensation from the open-type information sharing service provision server 300 when a content received in the cyber postbox is an advertisement and the advertisement is opened. Accordingly, a user can receive mail, messages, advertisements, etc. on the basis of grid coordinates of longitude lines and latitude lines even without signing up for email, SNS, or the like through the user terminal 100.

In this case, the user terminal 100 may be implemented as a computer that can access a remote server or terminal through a network. In this case, the computer, for example, may include a notebook, a desktop, a laptop, etc. equipped with a navigation and a web browser. In this case, the user terminal 100 may be implemented as a terminal that can access a remote server or terminal through a network. The user terminal 100, for example, which is a wireless communication device having portability and mobility, may include all kinds of handheld wireless communication devices such as a navigation, PCS (Personal Communication System), GSM (Global System for Mobile communication), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (WCode Division Multiple Access), and Wibro (Wireless Broadband Internet) terminals, a smartphone, a smartpad, a tablet PC, etc.

The open-type information sharing service provision server 300 may be a server that provides a webpage, an app page, a program, or an application for an open-type information sharing service using grid coordinates of longitude lines and latitude lines. Further, the open-type information sharing service provision server 300 may be a server that creates a cyber postbox on the basis of grid coordinates of longitude lines and latitude lines.

In this case, the cyber postbox may be a platform that can transmit/receive mail by searching for a position in a map on the basis of grid coordinates of longitude lines and latitude lines even without signing up for a specific portal site. Further, the cyber postbox may be floated in a map showing residential registration places of places, buildings, and natural persons, or may be floated in a road view. When a person who transmits mail searches a map and clicks or touches the cyber postbox floated in the map, the person can transmit an email, a message, an advertisement, etc. on the basis of an ID code created at a grid point of grid coordinates of longitude lines and latitude lines even though the person does not know the ID, email address, and name of the receiver. Similarly, a person who receives mail can output the contents received in his/her cyber postbox by searching his/her longitude line and latitude line coordinates, clicking or touching the cyber postbox floated at the searched coordinates, and inputting a password even though he/she does not undergo a process of signing up for a specific site or creating an ID. That is, similar to the offline mailbox, it is possible to install a cyber postbox in an online or cyber map and receive or transmit messages through the postbox. Accordingly, the open-type information sharing service provision server 300 may be a server that transmits a corresponding advertisement content to a cyber postbox included at the corresponding coordinates or area when the longitude line and latitude line coordinates or an area is received and selected from the at least one information provision terminal 400 and the advertisement content is received, and outputs the advertisement content on the user terminal 100 when the cyber postbox is clicked or touched in a map through the user terminal 100 and a password is input. Further, the open-type information sharing service provision server 300 may be a server that provides advertisement compensation as a reserve, etc. when an advertisement content is output from the user terminal 100. Further, the open-type information sharing service provision server 300 may be a server that removes a cyber postbox floated at corresponding coordinates in a map when there is a request to remove the cyber postbox from the user terminal 100. Accordingly, since even a user who cannot use email or does not want to sign up for email can receive an email on the basis of grid coordinates of longitude lines and latitude lines, accessibility and certainty leading ability of the user can be expanded. Further, since even people who advertise can advertise on the basis of the positions of areas or building, the lot numbers of lands, the addresses of natural persons even though they don't know personal information of receivers, so advertisement efficiency is increased. Further, individuals can use email even though they don't provide personal information, so personal information protection can be improved. In this case, the open-type information sharing service provision server 300 may be a server that can provide maps sequentially continuing from a small scale to a large scale such as a national map, an administrative district map, and a road map, and assigns one cyber postbox to each of creatures based on ID codes created at grid points of grid coordinates of longitude lines and latitude lines included in each of the map such that the cyber postboxes are floated in the maps. Accordingly, it is possible to provide a reality like going to a postbox in front of a door in a cyber space and to increase intuition.

In this case, the open-type information sharing service provision server 300 may be implemented as a computer that can access a remote server or terminal through a network. In this case, the computer, for example, may include a notebook, a desktop, a laptop, etc. equipped with a navigation and a web browser.

The at least one information provision terminal 400 may be a terminal that transmits advertisement contents including an advertisement email, an advertisement bill, etc. using a webpage, an app page, a program, or an application related to an open-type information sharing service using code numbers based on longitude line and latitude line coordinates. Further, the at least one information provision terminal 400 may be a server of an advertisement agent or an advertiser. To this end, the at least one information provision terminal 400 may be a terminal that performs membership registration and real name authentication on the open-type information sharing service provision server 300. Of course, it is not excluded that an information provider who does not have membership transmits an advertisement using the open-type information sharing service of the present disclosure. Further, the at least one information provision terminal 400 may be a server that receives advertisement-opening information of a user from the open-type information sharing service provision server 300 and pays for an advertisement fee to the open-type information sharing service provision server 300.

In this case, the at least one information provision terminal 400 may be implemented as a computer that can access a remote server or terminal through a network. In this case, the computer, for example, may include a notebook, a desktop, a laptop, etc. equipped with a navigation and a web browser. In this case, the at least one information provision terminal 400 may be implemented as a terminal that can access a remote server or terminal through a network. The at least one information provision terminal 400, for example, which is a wireless communication device having portability and mobility, may include all kinds of handheld wireless communication devices such as a navigation, PCS (Personal Communication System), GSM (Global System for Mobile communication), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), and Wibro (Wireless Broadband Internet) terminals, a smartphone, a smartpad, a tablet PC, etc.

The at least one home delivery terminal 500 may be the terminal that performs a home delivery using a webpage, an app page, a program, or an application related to an open-type information sharing service using grid coordinates of longitude lines and latitude lines.

In this case, the at least one home delivery terminal 500 may be implemented as a computer that can access a remote server or terminal through a network. In this case, the computer, for example, may include a notebook, a desktop, a laptop, etc. equipped with a navigation and a web browser. In this case, the at least one home delivery terminal 500 may be implemented as a terminal that can access a remote server or terminal through a network. The at least one home delivery terminal 500, for example, which is a wireless communication device having portability and mobility, may include all kinds of handheld wireless communication devices such as a navigation, PCS (Personal Communication System), GSM (Global System for Mobile communication), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), and Wibro (Wireless Broadband Internet) terminals, a smartphone, a smartpad, a tablet PC, etc.

The manager terminal may be the terminal of a manager that manages a request for deleting or registering a cyber postbox using a webpage, an app page, a program, or an application related to an open-type information sharing service using grid coordinates of longitude lines and latitude lines.

In this case, the manager terminal may be implemented as a computer that can access a remote server or terminal through a network. In this case, the computer, for example, may include a notebook, a desktop, a laptop, etc. equipped with a navigation and a web browser. In this case, the manager terminal may be implemented as a terminal that can access a remote server or terminal through a network. The manager terminal, for example, which is a wireless communication device having portability and mobility, may include all kinds of handheld wireless communication devices such as a navigation, PCS (Personal Communication System), GSM (Global System for Mobile communication), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), and Wibro (Wireless Broadband Internet) terminals, a smartphone, a smartpad, a tablet PC, etc.

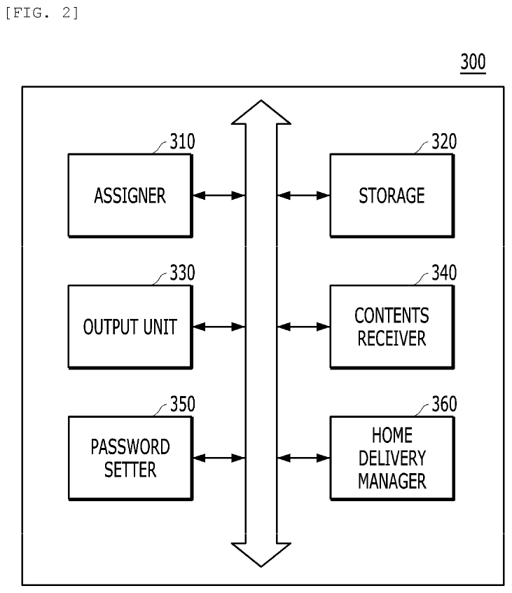

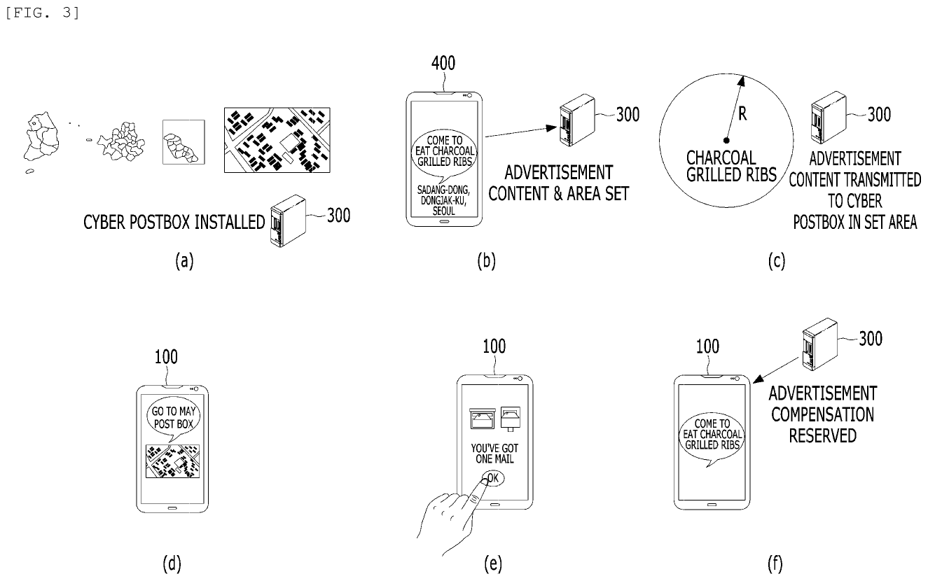

FIG. 2 is a block configuration diagram illustrating an open-type information sharing service provision server included in the system of FIG. 1 and FIG. 3 is a diagram illustrating an embodiment that implements the open-type information sharing service using grid coordinates of longitude lines and latitude lines according to an embodiment of the present disclosure.

Referring to FIG. 2, the open-type information sharing service provision server 300 may include a assigner 310, a storage 320, an output unit 330, a contents receiver 340, a password setter 350, and a home delivery manager 360.

When the open-type information sharing service provision server 300 according to an embodiment of the present disclosure of another linked server (not shown) transmits an application, a program, an app page, a webpage, etc. for the open-type information sharing service provision server using grid coordinates of longitude lines and latitude lines to the user terminal 100, the at least one information provision terminal 400, and the at least one home delivery terminal 500, the user terminal 100, the at least one information provision terminal 400, and the at least one home delivery terminal 500 can install or open the application, the program, the app page, the webpage, etc. for the open-type information sharing service provision server using grid coordinates of longitude lines and latitude lines. Further, a service program may be driven in the user terminal 100, the at least one information provision terminal 400, and the at least one home delivery terminal 500 using scripts that are executed on a web browser. In this case, the web browser, which is a program making it possible to use web (WWW: world wide web) services, means a program that receives and shows hypertexts described in HTML (hyper text mark-up language), and for example, includes Netscape, Explorer, chrome, etc. Further, the application means an application on a terminal, and for example, includes an app that is executed in a mobile terminal (smartphone).

First, the concept of a cyber postbox and an open-type information sharing service according to an embodiment of the present disclosure is described before FIG. 2 is described.

A method of providing an open-type information sharing service according to an embodiment of the present disclosure may create a 3D map using a grid based on a plane coordinate system based on longitude lines and latitude lines, the grid may include points, lines, and surfaces, and the points, lines, and surfaces may configure creatures individually or in a combination. Further, it may include a ropeway, an orbit, a longitude, a trace target guide line, a sensor, a traffic lane, a traffic road, etc. A new mail transmission/reception platform that provides map information on the basis of search information input by the user terminal and the 3D map and links map search icons is provided. To this end, in an embodiment of the present disclosure, the size of a grid in which inherent inter-line distances are derived by variation of the positions of longitude lines and latitude lines is set in consideration of precision in accordance with creation of driving roads and setting of map search routes, and the creatures may include a ropeway, an orbit, a route, a trace target guide line (e.g., the line of a drone as an object that guides an autonomous vehicle), a sensor, and the function and information of a traffic lane.

Further, the size of a map of one unit (image) and a search route that are elements on a series are configured on the basis of a grid, continuous configuration of cubes corresponding to (image) map units based on a series of arranged grids on one surface (in one direction), the cube includes information about a 4-surface picture and a 4-directional drone view (or air view) for replacing a road view corresponding to the grid, and the 4-surface picture and the 4-directional drone view may correspond to (match with) a map at grid coordinates of longitude lines and latitude lines.

Further, the cube may be included in a mother cube and the mother cube may further include information configuring a grid related to each cube, that is, information about a creature such as an ID code, an address, a street number, a certain serial number of a grid, and a numerical value (distance+position). Further, the mother cube, in the opposite way, may be disposed as a component at the lower end of a model of an individual cube that is a component of a series of an image map

A method of providing an open-type information sharing service according to another embodiment of the present disclosure configures traffic roads on the basis of longitude lines/latitude lines, and a processor that performs map search may be implemented to create a 3D map using a grid based on a plane coordinate system and to provide map information on the basis of search information input by a user device and the 3D map.

Meanwhile, the grid may include points, lines, and surfaces having the ID codes of coordinates, and the points, the lines, and the surfaces may configure creatures individually or in a combination.

An open-type information sharing service according to an embodiment of the present disclosure which has the objectives, configuration, and effect described above is described with reference to FIG. 2.

The assigner 310 can assign grid coordinates of longitude lines and latitude lines to the user terminal 100. The grid coordinates assigned in this way may have the concept of an address. However, even though one address is given, the households are different in a collective building, a merchant building, an apartment, or the like when the address is the same but the street number is different. Further, the residents who reside in corresponding house numbers or floors are different in accordance with the floor discriminator that discriminate floors or the house numbers in a small apartment or a one-room building. Alternatively, when a house number is not given because it is a common house, the household may be different even if the same address is given. Accordingly, when there is one household at one address, the address and the grid coordinates may be the same concept, but when there is a plurality of households at one address or there is a need for discrimination, an address may further include an identifier that can identifies each household, merchant building, etc.

In this case, the grid coordinates configure traffic roads on the basis of longitude lines/latitude lines, and a method of searching a map is used, an image map having high precision can be constructed.

For example, a common and image map (4-directional picture+4-directional drone view video) in which a plane coordinate system (longitude-latitude coordinate system) is shown on a 3D (dimension) numerical value (inherent position and distance of longitude⋅latitude lines according to each position) grid and a cube may be provided.

When a grid is shown in constructing and searching an (electronic) map, a numerical value (position+distance) based on longitude lines/latitude lines, so an ID code created at coordinates is an international common language or sign, and standardity (generality), precision, easiness, and stability thereof can be secured. When one grid is selected in accordance with a purpose, the magnitude (unit) of one numerical value (position+distance) for one grid may be set. The magnitude (unit) may be the unit of degree/minute/second of longitude/latitude. This unit may be shown to overlap a monitor when a map is searched. That is, the entire region may be covered with a 3D (cubic) grid (composed of each of longitude⋅latitude lines constituting one net) by a plane coordinate system implemented on the basis of longitude/latitude lines (horizontal×vertical).

Components (creatures) of points, lines, and surfaces that are elements on a grid may be applied to an augmented reality and a virtual reality. For example, a direction is indicated by an arrow in the related art, but a component created by lining on a grid according to a use and used at present as a direction indication graphic on a surface such as a road may be replaced by securing stability by giving a sensor function, etc. to the creature itself. Expression for 4D reflecting time and 6D such as direction/orbit may be corrected later in accordance with necessity and possibility.

Further, according to an embodiment, a line may be created by a combination of a longitude line/latitude line in accordance with a use on a 3D vertical grid map. That is, a line may be created and used by combining intersections, certain points, and lines on the basis of tying and lining in accordance with a use. A surface may be created and shown by combining lines according to a use. A 3D cube may be created and shown by combining points, lines, and surfaces according to a use.

Creatures configured by individual points, lines, and surfaces or a combination thereof on a grid in accordance with a purpose may be based on inherent position+distance of longitude⋅latitude lines and may function for each use. Further, a search line (shown as a 3D grid on a map in a layer mode) composed of longitude⋅latitude lines (vertical line×horizontal line) in which a numerical value (distance+position) as a kind of creatures may function as a place movement and trace search line of an air view, etc. Further, a creature may include a ropeway, an orbit, a route, a trace target guide line, a sensor, a traffic lane, aerial⋅overland⋅marine traffic roads, etc.

In particular, it is possible to give the role of a target function body by adding an additional device to a point, line, surface cube that is a combination element. That is, a line, a surface, and a cube created on a grid line may serve as a function element by being shown as a sensor for autonomous driving, etc., the IoT (internet of things) industry field, aerial photographing flying such as a drone, an air route, a traffic lane, a function body, and subject⋅object of a target trace object guide line. In particular, a 3D grid line is shown in an overlap mode in air view search, so it accurately and easily functions as a search means. Further, lines (horizontal×vertical) of a grid may be shown and may function as a search route and movement route of a (image, picture) delivery place by having various items of information (degree/minute/second numerical values of a longitude and a latitude).

A creature according to a purpose in a combination of line elements based on a grid of a longitude/latitude may perform a self sensor function or may function as a component as a subject such as recognition detection at a part where destination setting or numerical precision is required. That is, a complicated algorithm required for a recognition sensor and control in autonomous driving, etc. may be used for a simple/stereotyped ropeway, orbit, target trace object guide line, sensor, etc. Further, when augmented reality virtual reality (ICT (communication technology), IoT technology) are configured in a navigation field, etc., it may be applied to various creatures. It is possible to give functions required for autonomous driving. etc. to a creature by applying a GPU (graphic processing unit) technology, etc. to sensor function elements (particularly, ropeway orbit) of a point, a line, and a surface constituting a grid.

Configurations of a ropeway⋅an orbit⋅an air route⋅a trace target object (guided object) may be shown on a grid. An aerial vehicle can replace a line (which functions as a line hanging an aerial vehicle or a control movement guide line on the ground). A side bird's-eye view seen from a side can reflect an altitude.

Inherent discrimination according to a use may exist in a line, a surface, a cube, and a creature (a route, a traffic lane, etc.) constituting a 3D grid line. In a procedure of allotting and assigning information to a line, a surface, a cube, and a creature, information of an ID code based on longitude and latitude lines (horizontal line×vertical line) of a grid and inherent certain number and size, an administrative Dong, an address house number, and a surface (one of creatures of a grid) configured by a combination of position name lines of a creature may be assigned.

For example, a certain discrimination inherent serial number may be assigned to the above-mentioned creature composed of a line, a surface, and a cube. That is, an inherent discrimination number may be allotted like a first-line (individual line or combination of lines) movement path, a second-line (individual line or combination of lines) movement path. Similarly, it may be allotted and assigned like a first-Ho surface and a second-Ho surface, and an inherent certain serial number may be assigned to longitude and latitude lines constituting each grid.

Further, a built-in search function may be provided on a surface of a cube to be described below. Further, according to an embodiment of the present disclosure, an air route creation, search route setting, city and delivery place search image (drone view+4-directional picture) map may be constructed, and numerical values may be set on a grid for a specific purpose according to construction of a map.

For example, a numerical value (about 30 cm that is the unit of 0.01 second of degree/minute/second) on a grid may be selected to create and search an autonomous driving route. Further, in an image (drone view+4-directional picture) map for checking a delivery place, a destination, etc. and searching a route, a numerical value on a grid (numerical value of ⅙ corresponding to about an actual distance 200 m˜300 m) may be selected for the sizes of an image picture and a drone and air view of one grid in the corresponding area on the basis of a size that can replace a road view.

The storage 320 can store a cyber postbox as a content when a content at assigned grid coordinates of a longitude line and a latitude line is provided from the provision terminal 400. In this case, the at least one information provision terminal 400 may sets the address or area of a receiver. For example, let's assume that a NIKE standing discount store at Yangjae-dong wants to distribute handbills for a special price discount event of NIKE due to closing of business to the residents at Yangjae-dong. In the related art, they had to distribute mail to each house using a post office, etc., attach the handbills at Yangjae-dong, or employ people to put the handbills into each house at Yangjae-dong. However, according to the method of an embodiment of the present disclosure, at least cyber postbox assigned to Yangjae-dong is designated and an image of the special price discount event of NIKE due to closing of business is provided, whereby the above-mentioned entire time, cost, and manpower consumption is prevented and there is no possibility of a loss, tearing, or damage, so the handbills can be safely sent to the residents. To this end, the storage 320 can keep and store an assigned 3D grid coordinates of longitude lines and latitude lines for the code number of each cyber postbox and may further include a database or a server for keeping transmitted/received mails.

When a cyber postbox floated in a map is opened by the user terminal 100, the output unit 330 can output contents on the user terminal 100. In this case, the cyber postbox includes an identifier including a text, an image, or a video that is a result of classifying a business type as at least one category, so it may be further possible to search test even though an address is not known. A user (receiver) or an information provider (transmitter) both have to find out a cyber postbox floated in a grid map of longitude lines and latitude lines in order to access the cyber postbox. Of course, the transmitter may set an area and transmit mail to all cyber postboxes included in the area to sent mail and a receiver may directly access his/her cyber postbox through a favorite path, that is, through a shortened path without finding out the cyber postbox in a map to receive mail. Accordingly, when a user opens his/her cyber postbox on the user terminal 100, the output unit 330 can output mail or advertisement contents received in the cyber postbox. Next, when an advertisement content is opened on the user terminal 100, compensation may be given by transferring a reserve or cash to the user.

When a cyber postbox floated in a map is opened on the user terminal 100 and the output unit 330 outputs contents on the user terminal 100 and when a notice board printed with an ID code based on longitude line and latitude line coordinates of the cyber postbox of the user terminal 100 is pictured on the user terminal 100, the output unit 330 can output contents in the postbox on the user terminal 100 through an augmented reality. This will be described in detail below.

The contents receiver 340 can receive contents including a delivery place or a delivery area and an advertisement from at least one advertisement terminal (not shown) before assigning a cyber postbox including grid coordinates of longitude lines and latitude lines, which are assigned to each place⋅building or a residential registration place from the assigner 310, to the user terminal 100. In this case, the at least one advertisement terminal may be the at least information provision terminal 400 or not. The contents receiver 340 can assign a reserve to the user terminal 100 when a content is output from the user terminal 100. Keeping referring to the example described above, when the handbills for a special price discount event of NIKE which are distributed to the residents at Yangjae-dong are advertisement contents, the advertisement terminal can designate an area including all cyber postbox positioned within a radius of 5 km around the event place.

Meanwhile, grid coordinates of longitude lines and latitude lines may include a PR identifier indicating an individual business or a store. Further, when a search terminal (not shown) searches grid coordinates of longitude lines and latitude lines, the open-type information sharing service provision server 300 can control the position of a business or a map of a merchant building and a road view to be transmitted and output. When the search terminal searches grid coordinates of longitude lines and latitude lines, the open-type information sharing service provision server 300 can activate an interface for generating a call to an individual business place or store on the basis of SNS transmission/reception and voice recognition using an ID code created on the basis of the grid coordinates of longitude lines and latitude lines. In this case, the search terminal may be the user terminal 100 or not. The map may include 2D, 3D, 4D, virtual reality, or augmented reality map.

For example, let's assume that a searcher A remembers an approximate position of a store having tasty Jjamppong, but does not remember the name, the firm name, or the phone number, so the searcher A cannot order delivery of Jjamppong. In this case, since A remembers the approximate position where he/she ate Jjamppong, he/she can search for the position in a map to find out the Jjamppong store on the basis of the position. Further, since A may not clearly recognize the Jjamppong store in the map, he/she can recognize which one is the store with reference to a road view provided by the open-type information sharing service provision server 300. Alternatively, since grid coordinates of longitude lines and latitude lines may include the firm name, he/she can search stores having code numbers including the name Jjamppong around a position B in the map. In this case, when A clicks a cyber postbox icon mapped to a code number and floated in a map or a road view or says “make a phone call”, the open-type information sharing service provision server 300 can control the search terminal so that a phone call is made on the phone number mapped to the code number and stored.

Even though a user cannot search for a phone number because he/she remembers an approximate position but does not know the accurate firm name, it is possible to make a phone call through grid coordinates of longitude lines and latitude lines floated in a map using the open-type information sharing service according to an embodiment of the present disclosure, whereby it is possible to find out a phone number even if it is difficult to search the phone number on other portal sites. Further, it is possible to prevent a business place that receives a phone call from being charged even though the business places only provides a phone number when a portal site or a delivery application is used, and a searcher also can immediately know even the phone number based on an ID code of grid coordinates of longitude lines and latitude lines, so it is possible to certainly and subjectively make a phone call without specifically searching.

Further, when a ID code number of grid coordinates of longitude lines and latitude lines includes a PR identifier indicating an individual business or store and a notice board printed with grid coordinates of longitude lines and latitude lines is photographed by the user terminal 100, the open-type information sharing service provision server 300 can control PR contents mapped and stored in a cyber postbox to be output as augmented contents on the user terminal 100. For example, similar to the road-name notice board attached to each house, a code number may be attached to each house in offline. In this case, when the user terminal 100 photographs an ID code number, a cyber postbox icon is output to correspond to the position where the ID code number is photographed, and a user inserts a password, an animation, etc. is output on the user terminal 100 like a mail actually comes out of a postbox, whereby it is possible to implement an effect of actually using a postbox in offline on the user terminal 100. For example, lets assume that the ID code number of longitude line and latitude line coordinate grid point of 123, Banpo-dong, Seoucho-gu, Seoul, Republic Korea is 1234567 and the ID code number 1234567 is printed and attached to the door at 123, Banpo-dong, Seoucho-gu, Seoul, Republic Korea. In this case, a user terminal 100 that is a user residing at 123, Banpo-dong, Seoucho-gu, Seoul, Republic Korea turns on a camera and photographs 1234567 while entering his/her house through the door, the open-type information sharing service provision server 300 can output a cyber postbox icon in an image where 1234567 is positioned and output how many letters or handbills received in the cyber postbox through an image or an animation.

The password setter 350 can assign a cyber postbox including an ID code number based on longitude line and latitude line coordinates assigned for a specific place⋅building or each residential registration residence place of a natural person to the user terminal 100 and then transmit a password setting request to the user terminal 100 so that a password for opening the cyber postbox is set. Further, when a password is set from the user terminal 100, the password setter 350 can map and store the cyber postbox and the password. Keeping referring to the example described above, when there is no password, other people can photograph an ID code number and read letters of a neighbor through an augmented reality.

Alternatively, other people can search a map and read mail or handbills transmitted to a cyber postbox floated at corresponding longitude line and latitude line coordinates. In order to prevent this problem, a user is enabled to set a password that function as a key of a cyber postbox. Accordingly, a user who uses a cyber postbox can use email without signing-up or registering by setting a password of the cyber postbox already assigned to himself/herself on a system.

The home delivery manager 360 can assign a cyber postbox including an ID code number based on longitude line and latitude line coordinates assigned to each residential registration residence place by the assigner 310 to the user terminal 100 and can provide an article list to be delivered to the address of the user terminal 100 from the home delivery terminal 500 through an augmented reality when there is an article to be delivered to the user terminal 100 and the home delivery terminal 500 photographs a notice board printed with an ID code number based on longitude line and latitude line coordinates of the cyber postbox.

The home delivery service 360 can configure the size unit of a longitude line and latitude line coordinates grid for searching a delivery place image (picture and road view) and a movement route that are provided as a dual unit (the unit of one surface of a 3D grid of an image map constituting a cube may be selected and applied a numerical value of ⅙ corresponding to an actual distance of about 200 m˜300 m of degree/minute/second.

That is, the numerical value of an image map selected on the basis of a readability reference considering development of devices such as camera performance, a photographing technology, a subject distance based on a reference may be corrected and programmed in accordance with necessity. For example, a unit on a grid having an image (map) picture may be enlarged from 200 m of width×length to 300 mm.

For example, about 30 cm may be applied when selecting 0.01 second that is an allowable precision numerical value between creates such as a position between vehicles, a traffic road, a traffic lane required for autonomous driving of degree/minute/second.

A 4-surface picture and a 4-directional drone view for replacing a corresponding road view on a grid and in a cube may be provided therein. Information, a 4-directional picture, and a 4-directional drone view of an area corresponding to each grid may be provided therein.

When a grid for a specific area/specific purpose should be shown as a visible grid (that is, when a longitude and latitude numerical values should be selected and applied in a large scale), programming for changing, adjusting, correcting, and liming the numerical values may be performed. That is, a numerical value (distance) shown due to variation of longitude and latitude positions or variation of the applied scale may be programmed to be changed, corrected, and linked. That is, generally numerical value changing, correcting, and linking programming for converting an actual distance obtained by land surveying and measuring on a grid may be performed.

That is, since numerical lines, though depending on a scale, are finely shown with 0.01 second (20 cmm˜30 cmm) gaps at 1/5,000 that is fundamentally used in portal sites, etc. (that is, a grid cannot be visibly shown on a monitor), when a corresponding numerical value for a purpose is selected in accordance with a scale, the numerical value is programmed to be selected, converted, and linked into a numerical value that can be visibly shown or a search target part is enlarged through a device or software so that numerical value longitude and latitude lines and various creatures are shown and information can be visually searched on a grid.

Further, as for lines constituting a route in accordance with a purpose, it is possible to select and design a dual unit on the same map by separating/discriminating other map arts and a scale ratio (e.g., 1/5,000 is applied for parts such as buildings and 1/1,000 is applied for displaying a route in the same map). It is possible to correct and acquire information (grid coordinates of longitude lines and latitude lines, etc.) by layering Google map, etc. Further, according to an embodiment of the present disclosure, the following configuration may be used as a tool for searching for route movement on a grid and searching an image (picture+drone view) map for a delivery place.

Hereafter, an operation process according to the configuration of the above-mentioned open-type information sharing service provision server of FIG. 2 is described by exemplifying reference to FIG. 3. However, it would be apparent that an embodiment is only any one of various embodiments of the present disclosure and the present disclosure is not limited to the embodiment.

Referring to FIG. 1, (a) the open-type information sharing service provision server 300 floats a cyber postbox for specific place⋅building or each house in a map on the basis of longitude line and latitude line coordinates, and (b) receives an advertisement content from the at least one information provision terminal 400 and receives setting of longitude line and latitude line coordinates or an area where the advertisement content is delivered. In this case, when longitude line and latitude line coordinates are not set from the at least one information provision terminal 400 and area setting for transmission to a house hole in an area within R km from his/her store is performed, the open-type information sharing service provision server 300 transmits an advertisement content to a cyber postbox in the set area.

Meanwhile, (d) the open-type information sharing service provision server 300 requests a password when the cyber postbox floated at his/her longitude line and latitude line coordinates in a map is opened on the user terminal 100, and when the password input through the user terminal 100 is the same as a pre-stored password, (e) outputs the advertisement content delivered to the longitude line and latitude line coordinates of the user on the user terminal 100. In this case, (f) the open-type information sharing service provision server 300 accumulates advertisement compensation when receiving the advertisement content from the user terminal 100.

In addition, an embodiment of the present disclosure may further include a registration mail service. In this case, the registration mail service, which is an email service that provides functions similar to registration mail such as the functions of securing delivery to a receiver and checking reception, is a service that can be used as a means for the contents of the original message and attached files, which are transmitted to the longitude line and latitude line coordinates of a desired counterpart or a code number corresponding to the longitude line and latitude line coordinates, ownership, an legal verification of the transmitter at the transmission and reception times. The use purpose of an registration email may be classified in four types in a broad meaning. The first one is security of delivery, that is, securing delivery of the corresponding email to the cyber postbox at the longitude line and latitude line coordinates (showing the address with an ID code, the second one is checking of reception, that is, checking the fact that the receiver opens the mail, the third one is verification of delivery, that is, verifying the fact that an email having specific contents was sent to the email account of a specific person at a specific time, and the fourth one is authentication of the original, that is, verifying that the email contents transmitted at a specific time is not different from (the same as) the contents possessed at present.

Further, the open-type information sharing service of the present disclosure can provide a service that verifies integrity an electronic document using an electronic signature and a timestamp, and is a service that verifies that an event has electronically occurred for specific contents at a specific date in a reliable-based environment. The fundamental function of the open-type information sharing service of the present disclosure may include electronic signature authentication, time-stamping, security of secrecy, prevention of injustice, and event record. First, the electronic signature authentication may be used to guarantee of the transmitter's identity and verify integrity contents, all input terms remain as an evidence, may be used when dispute occurs later, and may use digital fingerprinting and signature authentication technologies based on PKI to check the document contents and integrity authentication. The second one is a time-stamping function. Time-stamping is performed with signature authentication of the present disclosure and the information processing date and time remain in the open-type information sharing service record of the present disclosure.

The third one is security of secrecy. A PKI-based encoding service is used to hide important business information from other people except for allowed people and shows a high security level. Accordingly, it is possible to 100% secure the privacy of stakeholders in a series of processes of encoding and decoding documents. The fourth one is prevention of injustice. The open-type information sharing service of the present disclosure can collect and maintain important records and evidences, which customers request in the process of progressing and processing electronic, commerce without omission. Accordingly, it is possible to secure reliability is an end-to-end process in combination with user authentication, time-stamping, message integrity, etc., it is possible to provide evidence data about whether there event details exist, integrity, and recording time to an individual or an organization, if necessary, and the evidence data can be reproduced as digital data or real data and transmitted to an evaluation institution. Finally, the event record function can be used as the key function of the open-type information sharing service of the present disclosure by keeping evidence data related to event processing. Accordingly, it is possible to prevent a situation in which registration of certification of contents for refund of deposit money for the lease of a house does not reach a receiver or a complaint is not delivered and to solve the problem that a complaint is not received due to inexistence of a receiver.

Matters not described with respect to the method of providing an open-type information sharing service using 3D grid coordinates of longitude lines and latitude lines of FIGS. 2 and 3 are the same as or can be easily inferred from those of the method of providing an open-type information sharing service using grid coordinates of longitude lines and latitude described above with reference to FIG. 1, so they are not described below.

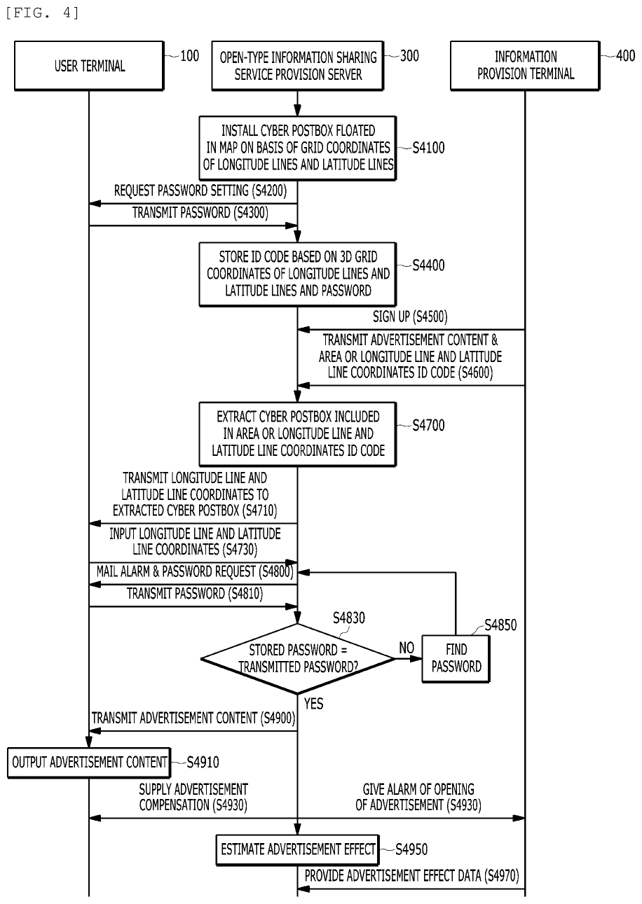

FIG. 4 is a diagram showing a process in which data are transmitted/received among components included in the system for providing an open-type information sharing service using grid coordinates of longitude lines and latitude lines of FIG. 1 according to an embodiment of the present disclosure. Hereafter, an example in which data are transmitted/received among components is described with reference to FIG. 4, but the present disclosure is not limited to the embodiment, and it is apparent to those skilled in the art that the process of transmitting/receiving data shown in FIG. 4 may be changed in accordance with various embodiments described above.

Referring to FIG. 4, the open-type information sharing service provision server 300 installs a cyber postbox that is floated on the basis of grid coordinates of longitude lines and latitude lines in a real map (S4100), requests setting of a password when there is a request for using the cyber postbox to the user terminal 100 or there is a response of use (S4200), and when a password is transmitted from the user terminal 100 (S4300), constructs an infrastructure of the cyber postbox by storing an ID code based on the grid coordinates of longitude lines and latitude lines and the password (S4400).

Meanwhile, the open-type information sharing service provision server 300 receives signing-up from the at least one information provision terminal 400 (S4500), and authenticates real names so that advertisements are not classified as spam mail and non-permitted advertisements or strange advertisements authenticates are not received the real names of advertisers by authenticating the real names of advertisers. In this case, it is apparent that various methods for preventing distribution of non-permitted spam mail may be used other than real name authentication.

Then, the open-type information sharing service provision server 300 receives advertisement contents and an area or longitude line and latitude line coordinates ID code from the at least one information provision terminal 400 (S4600), extracts a cyber postbox mapped to the area or latitude line coordinates ID and stored (S4700), and transmits the advertisement contents to the extracted cyber postbox (S4710).

In this case, a line of a grid can be selected/searched out on the basis of the transmitted advertisement contents. For example, it is possible to select and search for a movement route through a remote controller-type continuous push and functions of hiding lines, returning, and selecting the size of a grid can be performed on the basis of a route search engine.

Advertisement contents for searching may be used as a means for proposing a numerical value (distance) movement unit of a grid and a direction. The advertisement contents for searching can be linked with a numerical value unit for searching contents because a numerical value unit (distance+position) is in lines of a grid. Further, it is apparent that it is possible to select a search place using only a search direction and a search speed (continuous push function) of advertisement contents.

Further, advertisement contents can be adjusted on the basis of the principle of a touch, clicking a mouse, a TV remote controller, etc. Search grid line selection (or channel selection) is performed, and it can be moved by keeping pushing (e.g., a function type similar to volume adjustment) after selecting a movement direction. In particular, since it is possible to see 3D parts through an image in image map search, it is possible to check a search place by showing a search path on a plane longitude line and latitude line grid shown in an image not a 3D longitude line and latitude grid. Further, a function of moving the a target (place) can be performed by searching a corresponding numerical line (degree/minute/second 0 using a grid line hiding (restoring) function and a grid unit selection function. The same function may be performed only by entering and searching information. Further, the unit of an image map of a grid and a search path unit may dually⋅duplicatively serve.

In this case, the open-type information sharing service provision server 300 provides an alarm saying that there is a mail when a user inputs his/her longitude line and latitude line coordinates on the user terminal 100 or clicks or touches a cyber postbox floated in an area corresponding to his/her longitude line and latitude line coordinates in a map (S4710), checks whether a password is the same as the password mapped in advance to the longitude line and latitude line coordinates and stored (S4830) when password is input through the user terminal 100 (S4800 and S4810), and transmits an advertisement content received in the cyber postbox to the user terminal 100 to be output (S4900 and S4910). Further, the open-type information sharing service provision server 300 provides corresponding compensation when an advertisement content is opened on the user terminal 100 (S4930), and transmits the advertisement content was opened at what longitude line and latitude line coordinates to the information provision terminal 400, which may be shown by giving different colors to a house that opens advertisements and a house that does not open advertisements in a map, may be provided as list-up data such as Excel, may be provided as a chart or a diagram, and may be transmitted as a graph.

Accordingly, the open-type information sharing service provision server 300 estimates an advertisement effect based on an advertisement-opening rate (S4950) and provides the advertisement effect to the at least one information provision terminal 400 (S4970).

The orders of steps (S4100˜S4970) described above are only examples and are not limited thereto. That is, orders of steps (S4100˜S4970) described above may be switched, and some of the steps may be simultaneously performed or removed.

Matters not described with respect to the method of providing an open-type information sharing service using grid coordinates of longitude lines and latitude lines of FIG. 4 are the same as or can be easily inferred from those of the method of providing an open-type information sharing service using grid coordinates of longitude lines and latitude described above with reference to FIGS. 1 to 3, so they are not described below.

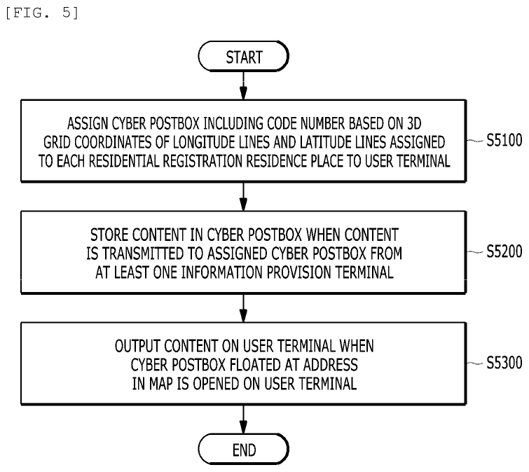

FIG. 5 is an operation flowchart illustrating a method of providing an open-type information sharing service using grid coordinates of longitude lines and latitude lines according to an embodiment of the present disclosure.

Referring to FIG. 5, an open-type information sharing service provision server assigns a cyber postbox including grid coordinates of longitude lines and latitude lines to a user terminal (S5100).

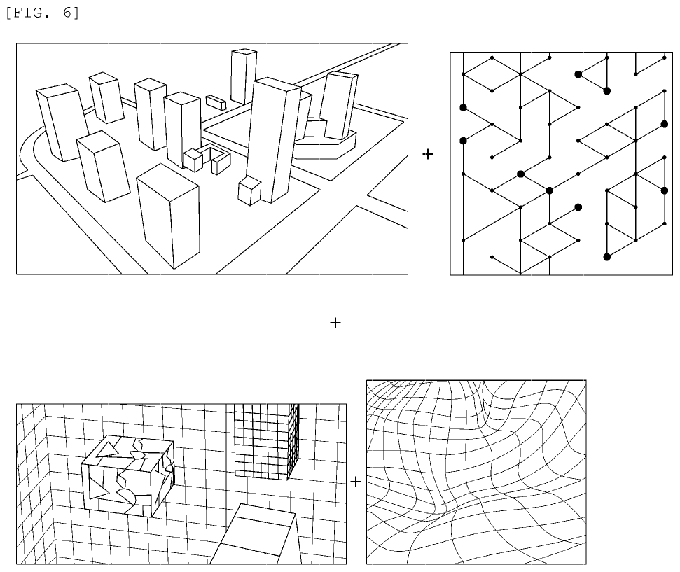

In this case, an open-type information sharing method using grid coordinates of longitude lines and latitude lines, as shown in FIG. 6, first shows grid lines created by connecting longitude line/latitude line coordinates in a 3D map (an open Kakao map, V-world, Google map, etc.) through an illustration, graphic, or display type.

Next, numerical values of coordinates in a 3D grid of longitude lines and latitude lines are secured. In this case, the numerical values of coordinates can be secured by matching, layering, etc. an open Google map.

Next, when a content is transmitted to the assigned cyber postbox from at least one information provision terminal, the content is stored in the cyber postbox (S5200).

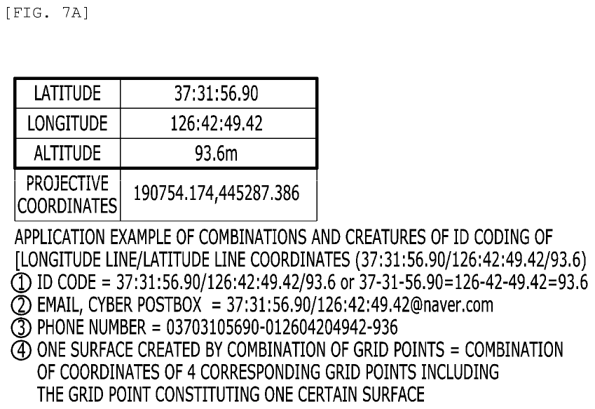

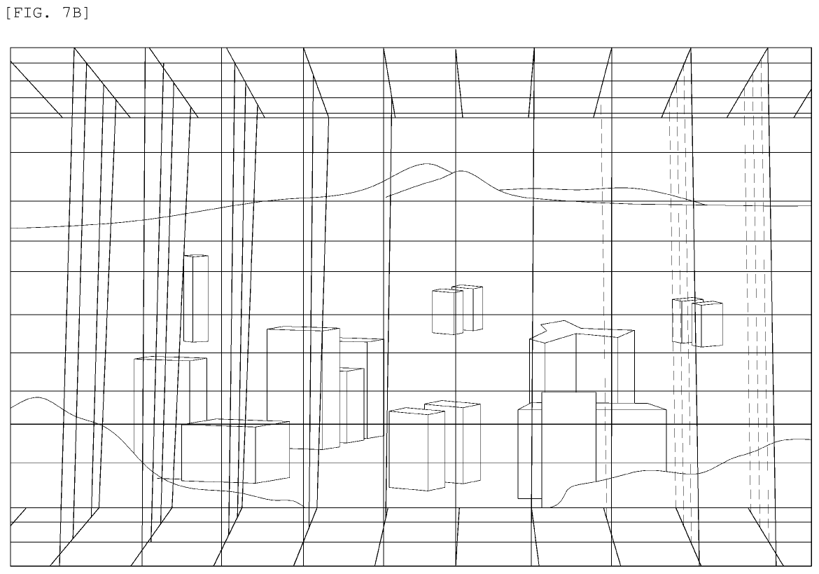

FIG. 7a is a diagram showing an embodiment of creating ID codes by combining coordinates of longitude lines and latitude lines and FIG. 7b is a diagram showing an embodiment of creating a visual grid map by a 3D perspective view of buildings matching with⋅passing through grid coordinates of longitude lines and latitude lines and of creating an ID code based on the map.

As shown in FIG. 7a, a content may include an inherent ID of an area, a land, a building, and a resident related to a specific position by combining inherent numerical values based on grid coordinates (longitude, latitude, altitude, projection coordinates, etc.) in a grid of longitude lines and latitude lines. Further, as shown in FIG. 7b, a content may include upper⋅lower inherent IDs of the same position specifying an altitude (or about a perspective visual map of 3D buildings matching with⋅passing through longitude line/latitude line grid coordinates to an upper surface grid or a perspective visual map of 3D buildings matching with⋅passing through an upper surface longitude line/latitude line grid).

Further, a content can add a house number, an address, etc. as combination elements of combination configuration conversion, ID, etc. for various uses (an ID, email, a phone number on SNS).

That is, as application example of combinations and creatures of ID coding of [longitude line/latitude line coordinates (37:31:56.90/126:42:49.42/93.6), there may be \textcircled{1} Id code=37:31:56,90/126:42:49.42/93.6 or 37−31−56.90=126−42−49.42=93.6 \textcircled{2} email, cyber postbox 37:31:56,90/126:42:49.42@naver.com, \textcircled{3} phone number 03703105690−012604204942−936, \textcircled{4} internet address (e.g., http://www.meokjacheonha.kr)=37:31:56,90/126:42:49.42 http://www.meokjacheonha.kr, \textcircled{5} physical⋅chemical⋅electrical quantum-dynamical complex of ID codes based on longitude line/latitude line coordinates, non-local relationship setting=(−) dynamic Id code: (−) 37:31:56,90/126:42:49.42, (+) static Id code: (+)37:31:56,90/126:42:49.42. \textcircled{6} There may be creation of digital money account number=37:31:56,90/126:42:49.42, \textcircled{7}IP address (Internet Protocol address))=37:31:56.90/126:42:49.42/93.06(≈218.237.65.1), etc.

Accordingly, it is possible to create a grid map by a general new administrative address system when designating or selecting the addresses of specific position⋅place⋅building⋅natural person using grid points, lines, surfaces, and cubes created by grid point coordinates (longitude, latitude, altitude, projective coordinates, etc.) individually or in a combination in the 3D grid of longitude lines and latitude lines.

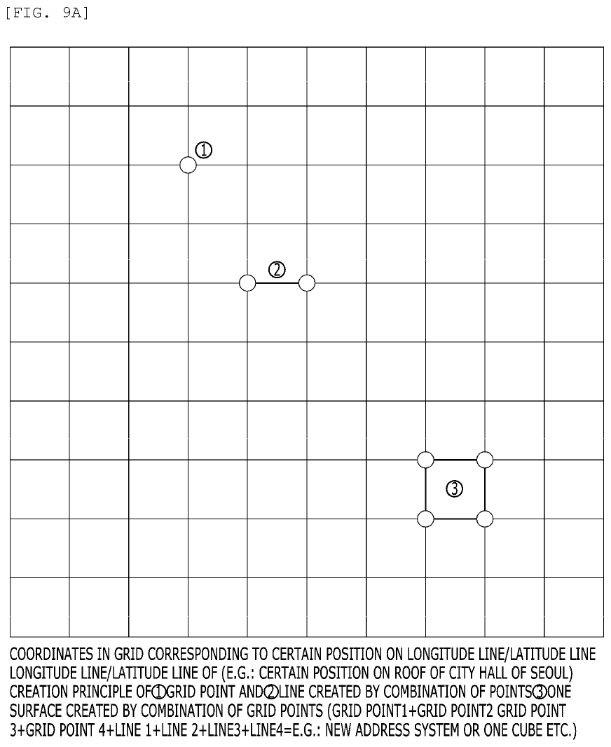

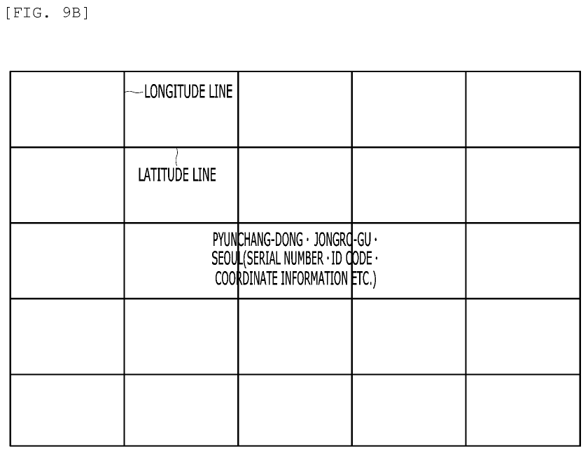

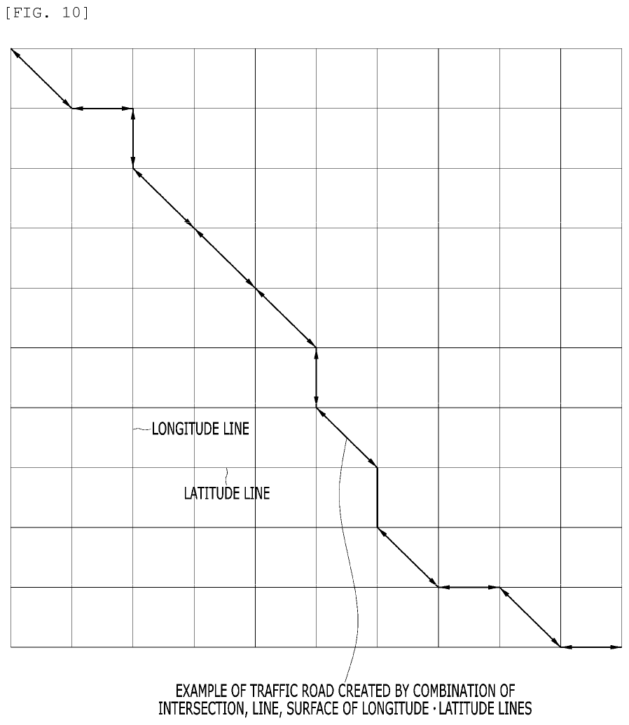

The grid points, lines, surfaces, and cubes created by grid point coordinates (longitude, latitude, altitude, projective coordinates, etc.) individually or in a combination in the 3D grid of longitude lines and latitude lines may include grid point, line, surface, cube information, respectively, shown in FIGS. 9a, 9b, and 10 by a hybrid HD mapping method, etc. FIGS. 9a, 9b, and 10 are diagrams illustrating a grip map and traffic roads created by points⋅lines⋅surfaces that are a kind of information derived at grid coordinates of longitude lines and latitude lines.

Accordingly, checking attendance⋅tendency and monitoring a security observation target through CCTV can check the present state of commute and find out online community⋅real-time SNS activity position⋅time by comparing position information ID (phone number, email, etc.) code number assigned by the ID code numbers of longitude line and latitude line coordinates with the current position proposed at present by GPS when moving.

Further, when monitoring and isolating a security observation target that is an object (e.g., a sexual criminal) wearing an electronic bracelet sensor (a mobile phone having a corresponding sensor linked with a location device such as GPS) having the ID code number, it is possible to find out the real-time position by linking with sensors installed at grid points⋅lines⋅surfaces of a longitude line/latitude line coordinates 3D grid.

That is, when a user assigned an ID code number derived by the positions of longitude line and latitude line coordinates in an inherent grid moves with the ID code in a mobile phone, etc., it is possible to find out real-time position movement in connection with a sensor.

Further, it is possible to find out real-time movement by installing a sensor lens on a creature of a point, a line, and a surface of a longitude line/latitude line-based grid or by remote control⋅server linkage of a drone, etc. for mounting a monitoring device (CCTV, etc.) on the creature.

Further, it is possible to create an individual ID code, which is matched and assigned to server⋅client and tangible (hardware)⋅intangible (software) input⋅output (software, hardware, etc.) constituting a computer network on the internet, as a user ID code, which is used as a social safety network device that pre⋅post prevents⋅recovers risks caused by anonymity of a concerned-person or illegal hacking by a third party in a non-facing industry, such as a remote medical service, remote education, and an online business required to specify a human⋅physical concerned-person or object, financial settlement, online advertising, and social media⋅commerce, by generally openly sharing and verifying the individual ID code when connecting to tangible and intangible internet through an interface, etc.

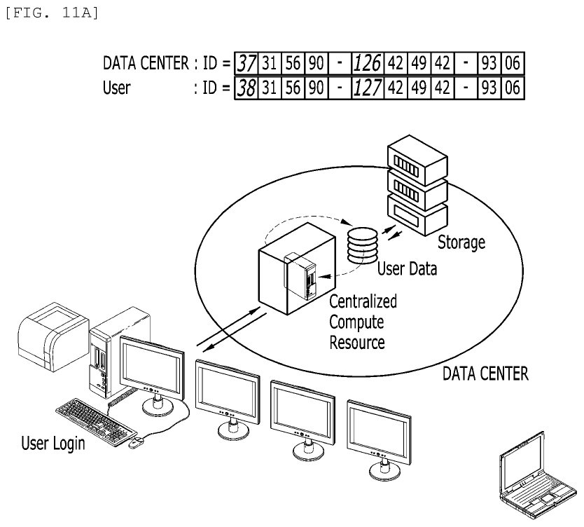

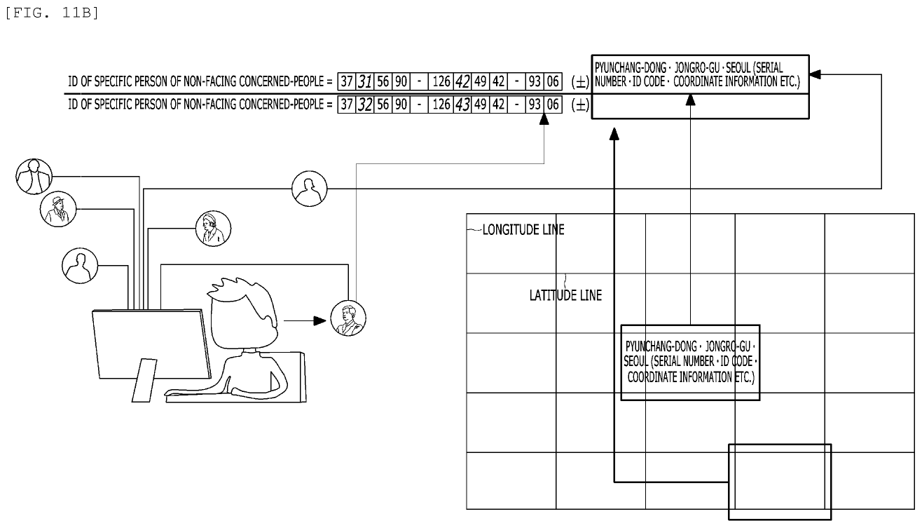

FIG. 11a shows an embodiment that is created and used as a user ID code using tangible⋅intangible systems of an ID code and FIG. 11b shows an embodiment that is applied to a non-facing industry such as remote education and an online business of an ID code, applies a user ID code, and creates and use inter-connector ID codes, location information, etc. that are transmitted received by a GNSS, etc. for real-time connection positions in a grid map of longitude and latitude lines.

Meanwhile, it is possible to use a movement⋅variation phenomenon of a corresponding object or natural person as a real-time trace verification tool or index by using characteristic⋅action, which are chemical⋅electrical quantum-dynamical complex or a sensor device linked with GPS, etc. to combinations of symmetric ID codes \textcircled{1} (+) static Id code: (+)37:31:56,90/126:42:49.42, \textcircled{2} (−) dynamic Id code: (−)37:31:56,90/126:42:49.42, etc. based on 3D grid coordinates of longitude lines and latitude lines that are matched with a specific place⋅object⋅natural person.

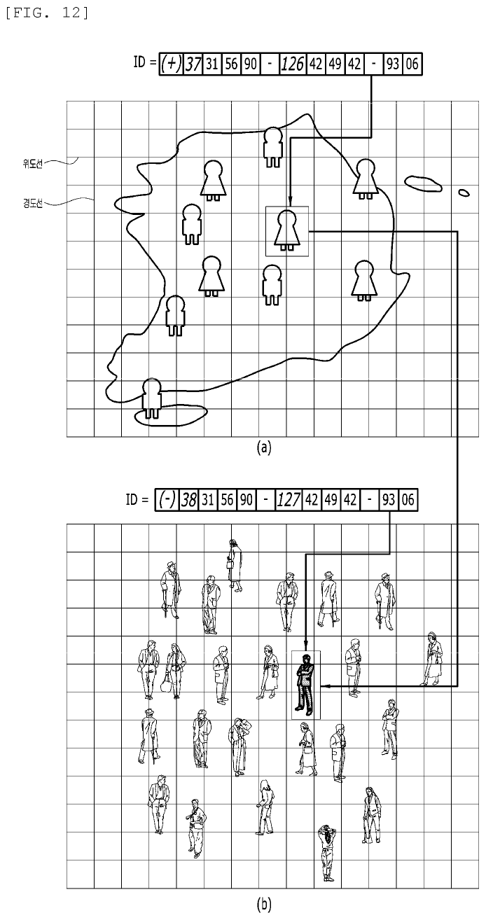

FIG. 12a shows an embodiment that is created and used as a user ID code using a prior-to-movement position of a specific person by applying a static (+) ID and FIG. 12b is an embodiment that is created and used as a user ID code using a post-movement position of a specific person by applying a dynamic (−) ID.

In addition, a defense net for a threat against military safety may be constructed. That is, it is possible to exclude a defense system by an interception method that is complicated and has many error and to construct a net for all-weather impregnable defense using a 3D longitude line/latitude line grid in a defense system against threatening weapons (which is necessary particularly against a low-altitude rapid-turn flying missile that is recently an issue) such as a missile, a fighter, or the like. As an actual example, when an attack weapon of an invader comes in contact with rubs with a creature of a point, a line, and a surface in a 3D grid of longitude line/latitude lines or when a sensing device in a creature detects that a threatening weapon of an invader enters a precise hit range, it is possible to suppress the invasion weapon using the sensing method that is the most reliable rather than an interception system based on a complex algorithm by a ground control system or a satellite control system. That is, it is possible to suppress weapons such as a missile or a fighter of an invader using a precise remote interception system by linking a grid of longitude lines/latitude lines, which has sensing and interception defense functions in a grid itself or the configuration or function described above, with a satellite system or a ground interception control system by configuring ultra-high electricity an air mine neta laser net, etc. in a altitude-based longitude line/latitude line grid. That is, it is possible to construct an altitude-based multiple longitude line/latitude line grid defense system (wire meshes) in order to construct a more reliable defense net.

Next, the open-type information sharing service provisions server outputs a content on a user terminal when a cyber postbox floated in a map is opened on the user terminal (S5300).

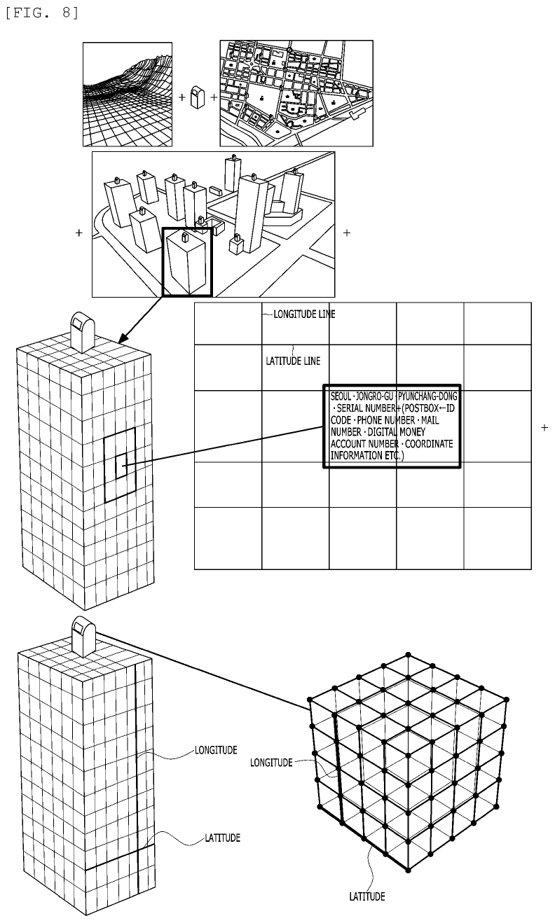

In this case, as the cyber postbox, as shown in FIG. 8, a cyber postbox having ID codes, etc. for specifying an area, a land, a building, and a relevant natural person matched with a longitude line/latitude line-based grid may be certainly floated. FIG. 8 is a diagram showing floating of a cyber postbox for a corresponding location and specific (selected⋅proposed⋅designated) object, internal⋅external model pictures⋅configuration derivation information of places⋅buildings matched with a longitude line and latitude line grid.

Accordingly, it may be possible to certainly⋅subjectively make a phone call or perform SNS transmission⋅reception by directly connecting to a cyber postbox floated at a building place, etc. in a map of a grid based on longitude lines and latitude lines or sensed and shown (graphed) grid map information, and to make a phone call or send a message through a real-time cyber postbox and longitude line and latitude line grid map information using a certain natural person and a corresponding position ID code number in a longitude line and latitude line grid map at a specific position (e.g., the current position of a natural person on a created surface) within a visible distance (visual distance) or a real-time connection position.

Matters not described with respect to the method of providing an open-type information sharing service using grid coordinates of longitude lines and latitude lines of FIG. 5 are the same as or can be easily inferred from those of the method of providing an open-type information sharing service using grid coordinates of longitude lines and latitude described above with reference to FIGS. 1 to 4, so they are not described below.

Meanwhile, pictures (4-directional and drone view, navigation view) of a delivery place and search target place (object) may be provided in a corresponding area image picture and drone and air views in one selected grid on the basis of a cube and a size that can replace a road view when it is an image (drone view+4-directional picture) for checking a delivery place, a destination, etc. and searching for a route. Search sections for searching for individual information in an area/section map and a grid (configured corresponding longitude lines and latitude lines) and information about a corresponding creature may be designed and provided on a cube. Further, a mother cube is set and the cube described above may be designed as a part. That is, a cube may be included in a mother cube and the mother cube may further include a numerical value related to the cube and information about a creature. Further, the mother cube, in the opposite way, may be disposed as a component at the lower end of a model of an individual cube that is a component of a series of an image map

The method of providing an open-type information sharing service using grid coordinates of longitude lines and latitude lines according to an embodiment described with reference to FIG. 5 may be implemented in a recording medium type including applications that are executed by a computer or commands that can be executed by a computer such as a program module. A computer-readable medium may be a certain available medium that can be accessed by a computer and includes all of a volatile and nonvolatile media, and separable and non-separable media. Further, the computer-readable medium may include all of computer storage media. The computer storage medium includes volatile and nonvolatile, and separable and non-separable media that are achieved any method of technology that stores information such as computer-readable instructions, data architectures, program modules, or other data.

The method of providing an open-type information sharing service using a code number based on longitude line and latitude line coordinates according to an embodiment of the present disclosure described above may be performed by an application (which may include a program included in a platform, an operating system, etc. fundamentally mounted in a terminal) fundamentally installed in a terminal, and may be performed by an application (i.e., a program) directly installed in a master terminal through an application provision server, such as an application store server and a web server related to an application or the service, by a user.

In terms of this meaning, the method of providing an open-type information sharing service using grid coordinates of longitude lines and latitude lines according to an embodiment of the present disclosure described above may be recorded in a recording medium that is fundamentally installed in a terminal or is implemented by an application (i.e., a program) directly installed by a user and can be read by a computer such as a terminal.

The above description is provided as an exemplary embodiment of the present disclosure and it should be understood that the present disclosure may be easily modified in other various ways without changing the spirit or the necessary features of the present disclosure by those skilled in the art. Therefore, the embodiments described above are only examples and should not be construed as being limitative in all respects. For example, the components described as single parts may be divided and the components described as separate parts may be integrated.

The scope of the present disclosure is defined by the following claims rather than the above detailed description, and all of changes and modifications obtained from the meaning and range of claims and equivalent concepts should be construed as being included in the scope of the present disclosure.

1. A method of creating and using an ID code number based on grid coordinates of longitude lines and latitude lines, the method using inherent information about a visual perspective map of grid coordinates of longitude lines and latitude lines matched or assigned to at least one or a specific place, building, natural person, and tangible⋅intangible system and object on the internet as an ID code number individually or in a combination, using an open-type information sharing service provision server.

2. The method of claim 1, wherein the visual perspective map is a visual perspective map of a 3D building matched with and passing through longitude line/latitude line grid coordinates in an upper surface grid, or a perspective visual map matched with⋅passing through a 3D building in an upper⋅lower surface longitude line/latitude line grid.

3. A method of creating and using an ID code number based on grid coordinates of longitude lines and latitude lines, the method using inherent information based on grid coordinates of longitude lines and latitude lines matched or assigned to at least one or a specific place, building, natural person, and tangible⋅intangible system and object on the internet as an ID code number individually or in a combination, using an open-type information sharing service provision server.

4. The method of claim 3, wherein the grid coordinates include a longitude, a latitude, an altitude, and projective coordinates.

5. The method of claim 3, wherein the ID code number includes
a step of creating a 3D map using a grid including a point, a line, and a surface on the basis of an plane coordinate system based on longitude lines and latitude lines, and
a step of using information of a creature, which includes a ropeway, an orbit, a longitude, a trace target object guide line, a sensor, a traffic lane, and a traffic road as an ID code number individually or in a combination.

6. The method of claim 5, wherein the 3D map provides a cube,
the cube is included in a mother cube and includes information about a 4-directional picture and a 4-directional drone view for replacing a road view corresponding to the grid,
the mother cube includes a numerical value related to the cube and information about a creature, and
the 4-directional picture and the 4-directional drone view correspond to (are matched with) a map at grid coordinates of longitude lines and latitude lines.

7. The method of claim 1, further comprising a step of creating a perspective visual map matched with and passing through 3D building⋅space by longitude line and latitude line coordinates as a new world administrative address system when specifying a position or a place, a building, and an address in a map using the individual or combined ID code number as open-type information.

8. The method of claim 1, wherein the ID code number includes a code number generally proposing a specific point or area using a point, a line, a surface, and a cube created by longitude line and latitude line grid coordinates.

9. A method of providing an open-type information sharing service that is executed in an open-type information sharing service provision server, the method comprising:
a step of assigning a cyber postbox, which includes combination⋅creation of a cyber ID card that is an ID code number based on grid coordinates of longitude lines and latitude lines assigned for each of specific position, building, and natural person's residential registration residence place;
a step of storing a content in the cyber postbox when the content is transmitted to the assigned cyber postbox from at least one information provision terminal; and
a step of outputting the content on a user terminal when the cyber postbox floated at a place⋅a building⋅an address in a map on the user terminal,
wherein the cyber postbox includes a text, an image, or a video that is a result of classifying a business type as at least one category, allots information about a line, a surface, a cube, and a creature (a route, a traffic lane, etc.) constituting a grid, and includes inherent certain number and size of an ID code number and a creature based on longitude lines and latitude lines (horizontal lines×vertical lines) of a grid, an administrative district, a address house number, and information about surfaces (one of creatures in a grid) configured by combining position name lines, as identifiers in an assigning procedure.

10. The method of claim 9, further comprising a step of receiving a content including a delivery place or a delivery area and an advertisement from at least one advertisement terminal before a step of assigning a cyber postbox, which includes an ID code number based on grid coordinates of longitude lines and latitude lines assigned to each of specific position, building, and natural person's residential registration residence place to a user terminal, and
when the content is output from the user terminal, a reserve is assigned to the user terminal.

11. The method of claim 9, wherein a code number based on grid coordinates of longitude lines and latitude lines of the cyber postbox includes a PR identifier indicating a business or a store of an individual,
an open-type information sharing service provision server controls the position of the business or a map and a road view of a store to be transmitted to a search terminal and to be output, when the search terminal searches for a code number based on grid coordinates of longitude lines and latitude lines or an address of the cyber postbox,
when the search terminal searches for a code number based on grid coordinates of longitude lines and latitude lines or an address of the cyber postbox,
the open-type information sharing service provision server activates an interface for transmitting a call to a business place or a store of an individual on the basis of recognition and SNS transmission/reception with a natural person corresponding to (matched with) a current corresponding longitude line and latitude line grid or coordinates by an ID code combined⋅created on the basis of 3D grid coordinates of longitude lines and latitude lines in the search terminal, and
the map includes a 2D, 3D, virtual reality, or augmented reality map.

12. The method of claim 9, wherein a code number based on grid coordinates of longitude lines and latitude lines of the cyber postbox includes a PR identifier indicating a business or a store of an individual, and
when a notice board printed with the code number based on grid coordinates of longitude lines and latitude lines of the cyber postbox is photographed by the user terminal, the open-type information sharing service provision server controls a PR content mapped and stored in advance in the cyber postbox to be output as an augmented reality content on the user terminal.

13. The method of claim 9, further comprising:
a step of transmitting a password setting request to the user terminal so that a password for opening the cyber postbox is set; and
a step of storing the pass word by mapping the password with the cyber postbox when the password is set from the user terminal,
after the step of assigning a cyber postbox, which includes a code number based on grid coordinates of longitude lines and latitude lines assigned for each of specific position, building, and natural person's residential registration residence place.

14. The method of claim 9, wherein the step of outputting the content on a user terminal when the cyber postbox floated in a map on the user terminal includes a step of outputting a content in a cyber postbox to be output on the user terminal through an augmented reality when a notice board printed with an ID code number based on 3D grid coordinates of longitude lines and latitude lines of the cyber postbox of the user terminal is photographed by the user terminal.

15. The method of claim 9, further comprising a step of providing a list of articles to be delivered to an address of the user terminal as an augmented reality from a home delivery terminal when there is an article to be delivered to the user terminal and a notice board printed with a code number based on grid coordinates of longitude lines and latitude lines of the cyber postbox is photographed by the home delivery terminal,
after the step of assigning a cyber postbox, which includes an ID code number based on grid coordinates of longitude lines and latitude lines assigned for each of specific position, building, and natural person's residential registration residence place.

16. The method of claim 9, wherein the grid includes a point, a line, and a surface,
the point, the line, and the surface constitute a creature individually or in a combination,
a size of the grid is set in consideration of precision,
the creature includes a diagram (graphic) of a ropeway, an orbit, a route, a trace target object guide line, a sensor (including a lens or CCTV), and a traffic lane,
a 3D map provides a cube,
the cube includes information about a 4-surface picture and a 4-directional drone view for replacing a road view corresponding to the grid,
the 4-surface picture and the 4-directional drone view correspond to (are matched with) a map at 3D grid coordinates of longitude lines and latitude lines,
the cube is included in a mother cube, and
the mother cube further includes a numerical number related to the cube and information about a creature.

17. The method of claim 9, wherein a creature configured by grid coordinates of longitude lines and latitude lines individually or in a combination includes a configuration of a general new world administrative address system and a visual perspective map of grid coordinates of longitude lines and latitude lines when a position or a place, a building, and an address are specified in a world map.

18. The method of claim 9, comprising assigning a function that can defense⋅suppress an invasion weapon to a creature of an altitude-based grid of longitude lines and latitude lines.

19. The method of claim 16, wherein the line constituting the route is expressed in a dual unit in a same map by separating and discriminating an other map part and a scale ratio in accordance with a use.

20. The method of claim 19, wherein a size of the grid for creating a route for autonomous driving is determined on the basis of a proximate value of allowable precision for autonomous driving, and
a size unit of the grid of longitude lines and latitude lines for searching a delivery place map and a movement route is configured as a dual unit.
